(19) United States
(12) Patent Application Publication
(10) Pub. No.: US 2014/0164142 A1
(43) Pub. Date: Jun. 12, 2014

(54) Method and System for Crossing Game-Features and Cross-Promoting Across Applications

(71) Applicant: Grant Chieh-Hsiang Yang, Fairview, TX (US)

(72) Inventor: Grant Chieh-Hsiang Yang, Fairview, TX (US)

(21) Appl. No.: 13/708,726

(22) Filed: Dec. 7, 2012

(51) Int. Cl. G06Q 30/02; A63F 13/12

(52) U.S. Cl. CPC G06Q 30/0273; A63F 13/12
USPC 705/14.69; 463/42

(57) ABSTRACT

A method and system for method for providing debt-driven cross promotion for an application. Developers register with the system, schedule cross promotion and if there is no conflict or an ability to split cross promotion traffic, receive cross promotion from all the available applications on the network. Cross promotion data is tracked to determine balances of each developer and prioritization for scheduling conflicts. Users that are cross-promoted from a game that may also have a cross-game feature are prompted to share the features across games. Cross-game features may also be used to cross-promote games in the network. Applications not in the network may still take part in the cross-promotion network through a proxy server to verify participation until their approval ranking is large enough for the verification signal to be throttled.

There are many types of applications on hardware devices, and many of these are video games. There are also many types of video games, these can include sports, actions, fighting, first-person shooters (FPS), etc. and within these games there are many genres, such as fantasy, science fiction, monsters, zombie apocalypse, etc. There are single player games, which are games played by a single player, and there are multiplayer games, those played by more than one player. Multiplayer games can include player versus player (PvP) games, team versus team, or player versus team, or a combination if there are multiple teams.

Due to the way many game markets work on application stores (“app stores”), on mobile application store (i.e. iTunes market for Apple, Google Play on Android, etc.), or console games (Xbox, Playstation), or Personal Computer (“PC”) downloads there is a high quantity of games, but also high fragmentation of the user base. This is due to the changing nature of the video game market. In the past, the goal was to capture “hard core” gamers, which were mostly young males. The methodology of acquiring a high number of users was extremely costly, as application (“app”) developers, a subset of which are game developers, frequently have to do a high level of marketing or work with a publisher. A developer or company enters into a publishing agreement, and, the publisher, for the most part, takes over the marketing effort in exchange for a share of profits.

In the present day, the definition of a common “tech user” or “video gamer” has changed. As technical devices like PCs, mobile phones (i.e. smartphones, feature phones), and tablets have become more prevalent, the demographic and market has both increased and become even more fragmented. The age group has significantly expanded, as even children are allowed to download apps on mobile phones and PCs, and the “older” age group actually grew up with the technical devices. Moreover, both men and women are downloading apps with similar frequency. However, men and women have significantly different interests, and this is largely part of the reason why markets are so fragmented. Developers who make one type or genre of game have to target by age group and sex, and it takes significant marketing to convert users outside the normal demographic to install the game. The first issue to overcome for developers is to acquire users, which is increasingly difficult to do without a large committed user base (generally non-existent for a startup company), or without significant money (also generally non-existent unless there is significant venture capital). The second major issue is how to keep those users once they have been attained.

For developers that do not have a significant number of their own apps on the store already or a significant number of users the ability to cross-promote (also known as “xpromo”, “x-promo”, “x promo”, “cross promo” or “cross-promo”), essentially advertise in-game, is diminished as the success of cross-promotion is largely dependent on the number of users that are in the network of an app that is cross-promoting to another app. For this reason, some developers and manufacturers have created Cross Promotion Click Exchange networks. These are networks that will allow a user to trade a cross promotion in one game in return for another game. Often times, it results in the network taking a “cut” by taking an ad to sell. The problem with this strategy is that it does not allow for a game to get to a significant success level to get into the rankings of an app store. Therefore, most apps with small user bases will generally languish in obscurity unless they attempt one of the more costly methods of user acquisition and even costlier measures to retain them. This is typically financially unsustainable for small mobile developers.

### BRIEF DESCRIPTION OF THE DRAWINGS

FIG. 1a illustrates a schematic of an example configuration of a cross promotion network with the ability to track incoming xpromo traffic, percentages, etc.

FIG. 1b illustrates a schematic of an example configuration of an xpromo and cross-game features with multi and cross-platform capabilities, wherein data may be processed through network communication on the client terminals.

FIG. 2a illustrates an example of how apps can enter the system and how one example xpromo may be structured.

FIG. 2b illustrates an example of how apps can enter the system and another example of how the xpromo may be structured.

FIG. 2c illustrates an example of how each Company's xpromo traffic may be credited.

FIG. 2d illustrates an example of tracking the relationships of sending and receiving for an individual company.

FIG. 3a depicts an example process flow of integrating new companies and apps into the debt-driven xpromo network and routing the bandwidth between the apps.

FIG. 3b depicts an example process flow of integrating new companies and apps into the debt-driven xpromo network and routing the bandwidth between the apps.

FIG. 3c depicts an example process flow of passing information between the various networks to provide the xpromo.

FIG. 4a illustrates an example of how apps can enter the system and how one example of xpromo may be co-structured with a cross-game feature (“shared feature”), even between apps of different genres or types.

FIG. 4b illustrates a more specific example of the types of features that may be crossed between games of different types and genres.

FIG. 5a depicts an example process flow of connecting a user to a cross-game feature after a user arrived at a game through xpromo.

FIG. 5b depicts an example process flow of a user using a cross-game feature.

### DETAILED DESCRIPTION

The first issue to overcome for developers is to acquire users. Developers can go to a publisher to market for them, or they can market themselves. “Marketing” typically includes buying ads, which is extremely costly. With non-monetary methods, user acquisition can grow organically or virally. Many interpret the methods of organic and viral growth to be largely interchangeable. Organic growth is growth that happens naturally without buying ads. Organic growth could be through appearance on rankings, getting a good review on a popular website that gets noticed by users, users specifically searching for the genre or type of app that a developer made, etc. Viral growth is colloquially known as word-of-mouth. This can be through “social” growth, such as a Twitter blast, a Facebook wall post, or getting some type of advertising, or it can be through simply telling your friends to install the game or sign on a user in order for you to play with them. The latter types of games are usually deemed as “social” games because they have social elements in their game that can lend to viral growth, as opposed to single player games that don't have those elements. But, even single player games can be viral, where if a user is gaining significant delight in the game, he can tell his friends to play.

Typically, app stores have “rankings” for apps, and getting into this list is usually a combination of high ratings by users and purchases by users. The purchase of an app usually includes the idea of downloading and installing an app, though is not necessarily always measured this way. For example, in a click exchange network, some networks interpret even the click on the ad and a view of the app on the app store as an “event”, otherwise known as a click-through, whereas others deem an actual install and opening of the app at least once as a minimal requirement. Purchases by users are typically weighted higher in app stores in terms of the rankings. Moreover, they are typically time-limited. In other words, in a hypothetical example, an app that is downloaded 365,000, spread out evenly over a year, will have only 1,000 downloads a day, which would not even get into the top 100 of the ranking on a market. Thus, organic discovery would be unavailable on the market. However, if an app is downloaded 365,000 in a year, but all occurring on a single day, then it has a chance of getting into the ranking, at which point significant organic discovery would occur.

To explain the deficiency of a click exchange network, if there is a hypothetical developer with a single app with 1000 daily average users, having 1 session a day, a session being a single entrance into the app until a user closes out of the app, then he could have multiple chances for xpromo. A daily average user is the number of users that open the app daily. This is different than the number of users that are in the system. In other words, the app in the hypothetical could have 7000 installs, or users, in the game's network, but they could each only play once a week; therefore, resulting on average of This depends on how many instances of a xpromo interstitial, or an ad typically placed in-between a user action, such as the completion of a game move, are shown. Alternatively, it could depend on the refresh rate of an ad. For example, an app could have a banner constantly running at the bottom and the banner may be set to a refresh rate of 1 minute, meaning every minute the ad shown refreshes to a new ad. If a user stays in the app for 3 minutes, he would have seen 2 refreshes and 3 different ads. Depending on the fill-rate and the cost per thousand (or “CPM”) rate, it may be possible that the ads may not actually be different. For example, if an ad network or xpromo network only has a single ad purchaser client, then 100% of the ads would be the same, regardless of the refresh rate. In this hypothetical example, if we say the app has an average rate of showing one xpromo per session, one session per day, then the developer in this example would send 1000 clicks from his app for xpromo. If the developer enters a cross promotion click exchange network that offered (a very generous) one-to-one ratio of an xpromo back from another app in the network for each xpromo ad sent by the app. Then the app would receive 1000 xpromos a day back. Typically, most ads result in a very low click-through rate (“CTR”) and an even lower install rate. If we hypothetically posed that we had a 10% CTR and a 1% install rate, then there would be 100 clicks but only 10 installs. Therefore, per day that app would receive 10 more “installs” a day. Therefore, if we are going at the same ratio that installs convert to DAU for the app, then only one-seventh of the installs are DAU. In other words, after the first day on the network, the DAU on the next day would be approximately 1001 to 1002.

On the other hand, if an app had the same CTR, installs, DAU ratio to install, click exchange ratio, etc. as above but had 3.65 million DAU instead of just 1000, then that app could deliver 3.65 million xpromo ads a day. It would get back 3.65 million xpromo and at a rate of 1% installs, it would only get 36,500 installs. As one can readily see, in order for this single app to get to a rate of receiving 365,000 installs to get ranked for sure, it would take a significant number of time from 3.65 million DAU, much less the 1,000 DAU in the hypothetical example. The example embodiments of the invention include systems and methods for allowing even lower DAU games to receive a significant number of improvements by providing a cross-promotion between game system by tracking the number of apps that have contributed to that app and the entering a pool such that there is no xpromo exchange, rather each app may be assigned a date, and it may be required to give back to apps in the system that have given at least one cycle of xpromo. The overall network is improved because its xpromo efforts improve not only the installs of one game, but the overall network is improved with organic installs. This gain in the xpromo system cannot be replicated by a simple click exchange.

Moreover, a click exchange network does not allow you to have debt rather it gives a click per a click you provide first. However, in the debt-driven xpromo module, system, and method, an app is allowed to continue to hold debt in terms of volume, as long as it is always contributing. Apps are generally a hit-based business, particularly with specific types of apps like games. It is difficult to know which apps will be successful, therefore, to rely on a simple click “exchange” does not allow for the growth that can be gained from an app hitting the “true” organic market, which is the market rankings, in order to determine whether an app is actually a hit. Moreover, apps that are not “hits” are not punished for not being “hits” so long as they contributed to the organic growth of an app that was a hit and that adds users to the overall debt-driven xpromo network.

Another problem with the cross promotion click exchange networks are that they are all on their own “platforms” and each has their own software development kits (or “SDK”). There are two problems with this. First, the volume of traffic that can be delivered by a network is limited by the number of apps that are in their platform, in other words, the apps delivering xpromo traffic can only go within the network. Second, the network protocol or delivery of the information is typically through the SDK, but not all click exchanges have an SDK for each type of language of the mobile device or to the particular game engine. For example, iOS may be written in objective C, Android mobile devices are typically in Java, and game engines, such as Cortona or Unity have to have their own SDK's or plugins in order to integrate with many mobile apps. Moreover, integration of each SDK for each click-exchange network takes a significant amount of time; therefore, most apps only choose to integrate with one network. Typically, games that are of similar genre or type will xpromo better to each other; therefore, even if an app may be in a particular xpromo network that doesn't have a lot of similar apps, then it may get even worse install rates for the traffic it sends.

Even spending significant amounts of money or getting high install rates from a cross promotion network does not necessarily translate to retention of those users, meaning users who continue to play the game after first discovering, installing, and playing the game. As mentioned above, an app's DAU is typically a subset of the overall user base, usually measured by the user's engagement, which is the amount of times a user opens the app over a specified period. The specified period is typically a week-long engagement or a month-long engagement.

Even if a user installs the app, they are far less likely to be retained if they do not enjoy the type, genre, or concept of the app itself. Some developers try to solve this problem by giving using rewards for using another app. For example, a hypothetical “App A” may entice a user to install and engage in “App B”, and offer rewards in “App A”, such as by awarding in-game virtual currency or unlocking avatars, levels, or other features and content. However, this becomes costly for the games for two reasons. First, engagement in this type of promotion typically declines quickly. The reason is because awarding of in-game currency becomes tedious to some users because they may not have the time or energy to use an “App B” that they do not enjoy. Users that seek a significant number of in-game currency will ultimately have to make an in-app purchase (IAP) for that currency, and this amount typically far exceeds a “reward” amount. Second, creating un-lockable content is typically an expensive development process from both the perspective of a programmer having to create the unlock feature and its behavior, but also from an art perspective, as the most appealing un-lockable content tends to be successful when it is aesthetically enticing and pleasing. However, this may be a waste of resources because only a subset of users will choose to gain un-lockable content in this promotional manner.

Example embodiments of the invention include systems and methods for integrating apps across any network tracking and awarding apps that have already provided xpromo via “debt”. Apps that have not given xpromo, but have gotten xpromo are given a “debt” variable that is tracked to ensure that the particular app will have to pay off the debt later by providing xpromo. Moreover, a percentage or volume variable may be tracked so that on particular days if an app has to allocate its ad resources to something else, or if it added a new xpromo feature that wasn't available initially, that games that are in its “debt” can pay back at the same percentage. This also allows apps to accrue a significant amount of positive promo so that it can get debt back at crucial times. For example, an app may prepare to do a “sale” promotion or ad purchases on a certain day. If it coordinates it with the day that it can get cross-promoted, it ensures a much higher likelihood that it can get the installs it needs to get into the app rankings.

In a prior paradigm “App A” encourages users to use “App B” in order to gain un-lockable content in “App A” when a user has done the requested actions in “App B”. Alternatively, “App A” may be enticed to use a feature in “App B” by giving it a special avatar that may be only used in “App B” if the user had previously used “App A”. For example, an app may award an avatar with a specific feature, such as a special powerup or clothes that look special; however, this content and behavior is static and does not change once awarded. The “state” of the content in which it can be affected by both “App A” and “App B” would need to be compared, controlled, and verified so that it's behavior affecting the gameplay corresponds to the user's use of the apps that are linked. If this can be achieved, then retention would be expected to be higher than simply a static award.

The example embodiments also describe integrating or crossing features across games so that they can actually be used within the other games when those features are not typically part of the gameplay of its respective game. Example embodiments explain how a server backend and a methodology of tracking changes in the state of a cross-game feature may be used to affect the gameplay of both “App A” and “App B” and possibly even an “App C” without using simple static unlocked content. Game designers and games do not use gameplay features that are not related to the game because (1) users become confused and (2) it is difficult to balance scoring, attributes, etc. and integrate those features to affect gameplay elements that are not related to the game.

Detailed descriptions of the above example embodiments may be illustrated herein.

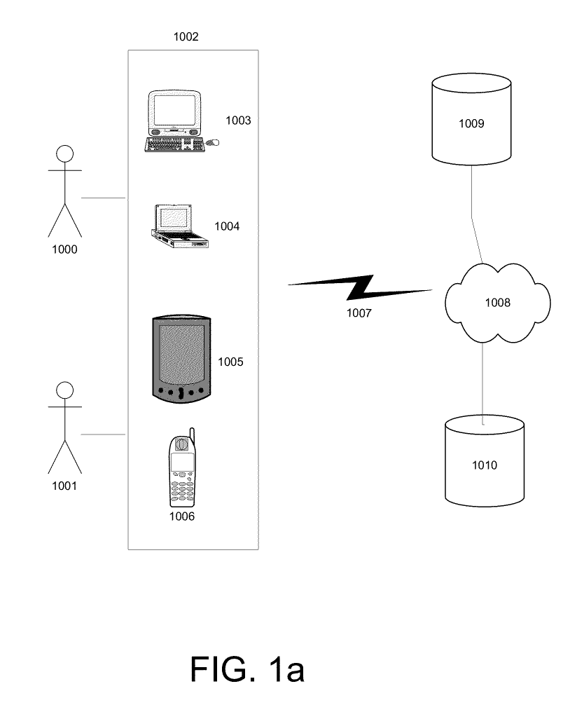

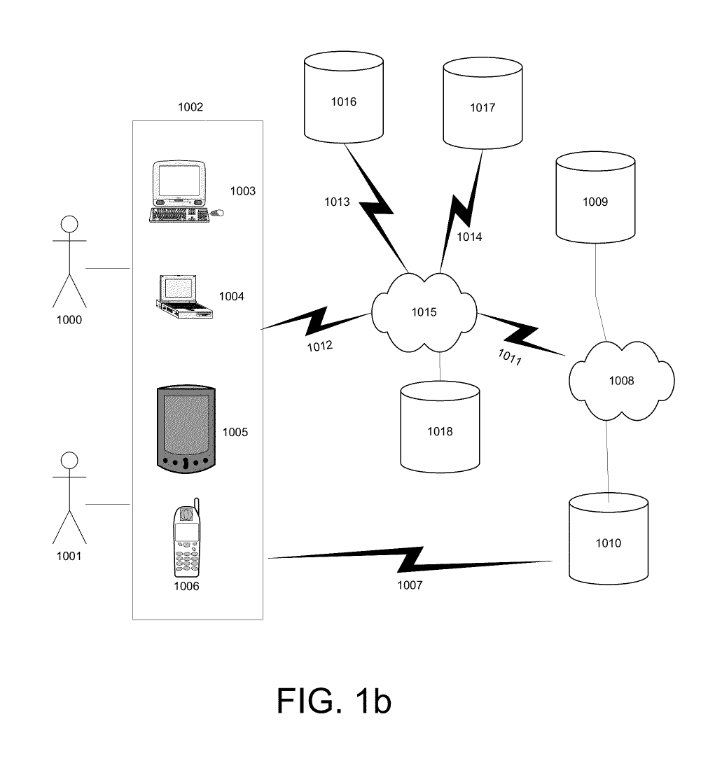

FIG. 1a illustrates a schematic of an example configuration of a cross promotion network with the ability to track incoming xpromo traffic, percentages, etc., which for purposes of brevity we will call the “debt-driven” cross promotion network. The schematic depicts the data flow of xpromo between the apps on the system. Humans 1000 and 1001 (who may be users, players, etc.) may access client terminals 1002, which may be a larger client device like a desktop 1003 or laptop 1004 or may be a handheld device, such as a smartphone 1005, feature phone 1006, or any other number of client computing devices, such as a tablet, PDA, etc. that are not depicted. It is noted that the system may not be limited to only two users, and there may be multiple client terminal 1002 configurations per user. The client terminals 1002 may be an interface such as a web application or a stand-alone application on a smartphone or other client in any number of formats. The client terminals 1002 may interact through a communication link 1007 to a network 1008.

The communication link 1007 may communicate over a network through any number of networks 1008, such as through servers or proxy servers, through the internet, through portions of a network, through an ad hoc network, an intranet or extranet, through firewalls, over a virtual private network (VPN), local area network (LAN), wireless LAN (WLAN), wide area network (WAN), wireless WAN (WWAN), through public or private networks, and the communication link may be over number of fiber, cable, satellite, DSL, wireless or other form of technology or communication, or a combination thereof.

The network may in turn communicate with an xpromo module 1009 which may process and store the debt-driven data. The network 1008 may also connect to a cross-game feature module 1010 which may process, store, and track features or state of the features across users and games. The xpromo module 1009 and cross-game feature module 1010 may be servers that contain the instructions to perform the processes of any data moving across the apps. The database of the modules may also store information and be able to retrieve the information and to send to different client terminals 1002 of the users 1000 & 1001.

In all instances of FIG. 1, anything that may be completed over a network may also be configured to be completed on the client, on the server, on a combination of both, or executed exclusively on one device and have any information, data, content, network packet, etc. \passed and parsed on another device. Moreover, in all instances of the system in FIG. 1, any storage of information that may be sent from a client may be processed and stored in a single module on a single database, or may be distributed across multiple servers. Moreover, the clients or servers or other computing devices may be arranged in any number of methods, including different types of mass storage, processors, cache, etc. The processing units may be any variation of processing technology, including but not limited to, central processing units (CPUs), graphic processing units (GPUs), etc. or other processing modules. The database methodology may interact between different paradigms or data structures. For example, one server may store data in a relational database, whereas another server may store data in a document-oriented database. Whatever the type of database paradigm or structure, the system and methods will be allowed to interact with each other. The input/output (I/O) method may be across a high performance bus or any combination of I/O technologies and the client and server devices may run on any single or combination of operating systems, including but not limited to the Windows, LINUX, UNIX, Apple Macintosh, etc. The storage elements may be consist of any type of non-transitory storage media, including but not limited to, tapes, disks, dynamic random-access memory (DRAM), optical disc drives, volatile memory that may be later transferred to non-volatile memory components, optical memory storage, flash memory, etc. and in any type of configuration, such a single storage devices, redundant array of independent disks (RAID) configurations, cloud storage, etc.

The (a) storage and processing of data for the (b) xpromo or cross-game features may be on the (c) same server, distributed across servers, or passed to the client by any permutation or combination or partial combination of (a), (b), and (c) above. In a non-exhaustive list of some examples: (1) storage of xpromo and cross-game features may be stored on a single server but processed on a different server; (2) Alternatively, storage of xpromo may be stored and processed on one server and storage of cross-game features may be stored and processed on a different server; (3) Alternatively, storage of xpromo may be stored a first storage server, storage of cross-game features may be stored on a second storage server, and both the xpromo and cross-game features may be processed on the client devices; (4) Alternatively, storage for xpromo may be distributed across client and servers but processing may be on a separate server.

FIG. 1b illustrates a schematic of an example configuration of an xpromo and cross-game features with multi and cross-platform capabilities, wherein data may be processed through network communication on the client terminals. For example, as in the previous example, there may be one or more users 1000 & 1001 using one or more apps on client terminals 1002 of various types of client device types 1003-1006. Data may be transported over communication links 1007 & 1012 through various networks or clouds 1008.

Data may potentially transmitted directly via a direct communication link 1007, or data may pass through various an indirect link 1012 through a cloud connecting to other click exchange networks (one or more represented by 1016) or non-click exchange ad networks (one or more represented by 1017) that communicate through the links 1013 and 1014, respectively. The click exchange networks 1016 and the ad networks 1017 can pass data from the clients 1002 through the communication links 1011-1014 back through other networking clouds 1015 to the cloud 1008 routing data to the xpromo module 1009 and the cross-game feature module 1010. Or, in addition, some of the processing of the data may be processed, consolidated, or stored in a pre-processing module 1018. Some data that may be needed for xpromo may simply need to be aggregate data and individual information may not be needed. For example, a pre-processing module 1018 may consolidate the number of xpromo shown by an individual user and pass that to the xpromo module 1009. Alternatively, the pre-processing module may consolidate further and simply gather all the number of all xpromo shown by all users on a single app before passing this information along to the xpromo module 1008. Or, alternatively, the pre-processing module may gather the xpromo shown for all the users on an app, but split this information by the platform, such as by iOS and Android devices, or by the type or manufacturer of phone. For example, Apple makes all the iOS products, but within Android phones, there may be Samsung, LG, etc. Or, the pre-processing module 1018 may consolidate by operating system (OS) version.

For example, if there is significant fragmentation of OS usage by users of a particular platform, or if there is widespread adoption, then some apps may only be available for a minimum version. Other apps may only be available for a maximum version. The reason for a minimum version may be because an app may not be optimized for lower versions or may run slower or incorrectly. Rather than risk getting bad user reviews, an app may simply not have the app available on the market for a lower end device (the “end” can refer to hardware, chipsets, resolutions or varying aspect ratios, etc.) or a lower OS version. On the other end of the spectrum, a developer may not make an app available on a higher OS version or a higher end device because of changes to specifications for the new OS that would break the app in its current state, potentially by causing exceptions or if the OS is not made to be backwards compatible, or if the devices with the newer OS's are on different resolutions with different aspect ratios for images. In such an instance, an app developer may not make its app available on a higher end device, etc. or higher OS versions. Nevertheless, it would be difficult to coordinate which apps are capable of actually giving xpromo to other apps if there are limitations. For example, an app that has a minimum OS version of 3.0 on a platform would not give useful xpromo (other than for purely word-of-mouth advertising) to an app that has a maximum version of OS version 2.9. Depending on which factors the xpromo wants to consider for counting the “debt” provided by the xpromo, if in the example above the primary matter is purely based on the volume of xpromo provided, then processing may be first done on a pre-processing module 1018 to provide the information. If, on the other hand, in alternative setup where the OS versions and things of that nature are also consider, the pre-processing may pass on more of the information to the xpromo module 1009 to handle. Ultimately, depending on which factors are considered in the xpromo system, data can be stored and/or processed by the client device 1002, the pre-processing module 1018, the xpromo module 1009, or any of the similar permutations and combinations described regarding (a) storage and processing; (b) device or server that handles the actions, and (c) distribution, whether partial or full, of handling those actions.

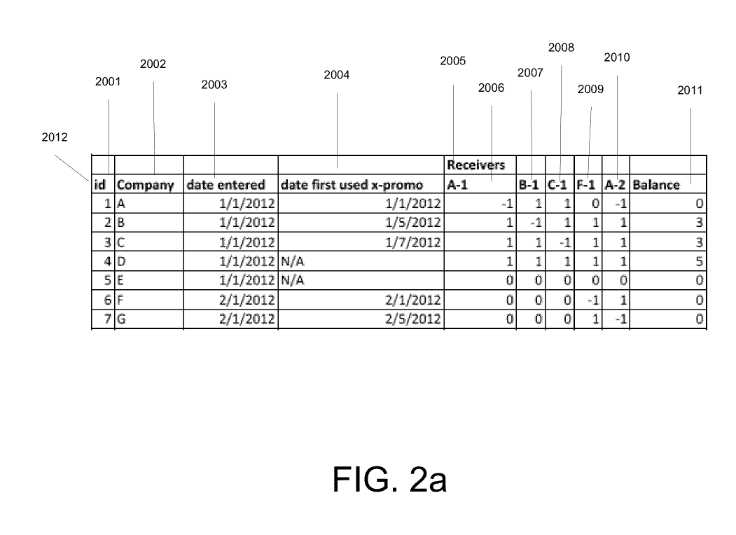

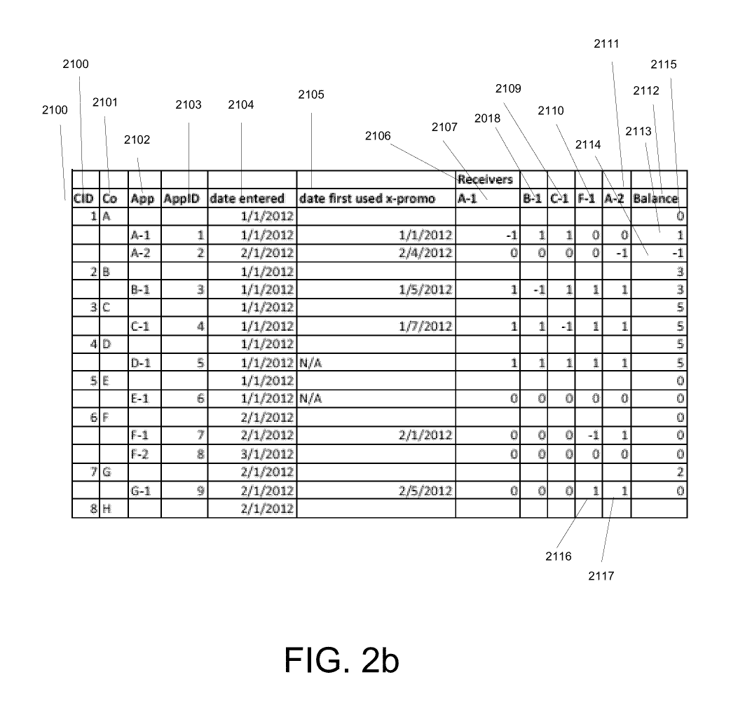

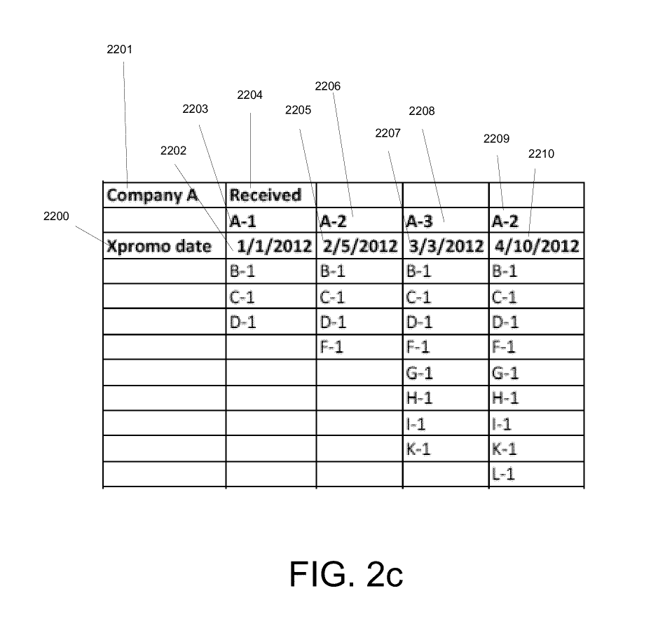

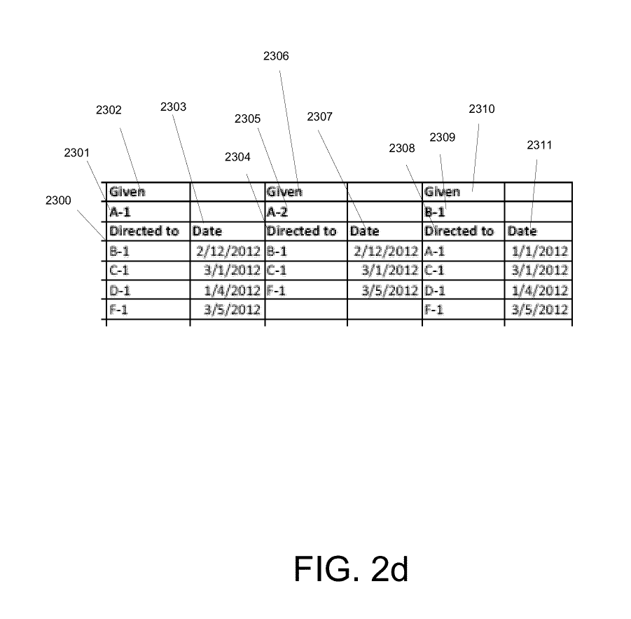

FIG. 2a illustrates an example of how apps can enter the system and how one example xpromo may be structured. The table shows several columns and rows. Row 2012 indicates the headers of the columns that indicate the type of values in the rows below. Column 2001 is the id. The id simply identifies the company in column 2002, providing a value rather than the name. Column 2002 is the company or developer, and for ease of the example, the names of the company are simply letters. Column 2003 provides the date entered, which may be the date the company actually entered the xpromo network. For example, companies that entered later in time, such as Company F entering in “2/1/2012”, would not even had the opportunity to provide xpromo for a company that was receiving that xpromo earlier than the date Company F entered. Column 2004 provides the date that a company first used xpromo within the network. From column 2005 onwards, all the columns listed are the receivers of the xpromo, in particular the specific apps by their id#. For ease of readability, the apps are simply listed by the Company-#, where the Company may be related to the company in Column 2002, and the # is an id number indicating the app number per Company (for ease of understanding, the app getting xpromo from other apps may be alternatively referred to as the Receiving App, Receiver App, simply Receiving or Receiver). Therefore, as can be seen in Column 2006 and Column 2010, Company A has two apps that have received xpromo, one is Receiver A-1 and the other is Receiver A-2, respectively. A-1 and A-2 are two separate applications receiving xpromo from other companies, from their apps, in the system. Otherwise, Columns 2007 through Column 2009 indicate other apps that have received xpromo in this example. Finally, the Balance in Column 2011 provides the debt-tracking snapshot up until that point.

As explained above, FIG. 2a only provides an example snapshot of how various companies may have contributed their apps in the above scenario. For ease of understanding, the network initially consists of 5 companies all starting on Jan. 1, 2012, or “1/1/2012” as displayed in Column 2003. This means that when Receiver A-1 first receives xpromo, there are at least 5 companies available. All of the companies may not necessarily have an app to contribute xpromo at this time, but they can be signed up into the group. In the particular example, though, we find that they all have apps contributing except for Company E, which as seen in its row, it doesn't contribute any xpromo to any of the apps in the network. This could be because it does not have apps to contribute; alternatively, it could be because it did not want to contribute. If it simply chose not to contribute, then it would not have necessarily been able to have a positive balance against those specific companies or apps, as will be explained later. App A-1 of Company A first receives its xpromo on “1/1/2012”. At this point, it acquires a debt of “−1” against all the other companies that provided xpromo to App A-1, which would be companies B, C, and D, which are given a “1” in Column 2006. The “1” here indicates that it has provided 1 app that gave its xpromo to App A-1. The “−1” indicates that it has a debt to those apps that gave it xpromo, and that later on it must reciprocate xpromo to those apps.

Simply because a company may be providing xpromo does not mean that it has to get its xpromo back in the specific order that it gave it, although it may not be precluded from doing so. For example, as we can see in FIG. 2a, App A-1 receives its xpromo first, and App B-2, which had given xpromo, decides to call in that debt from App A-1 but also acquire a debt of its own from other apps. The calling in the debt can be done by scheduling when it wants to receive the xpromo. The system handles that request by mandatorily requiring every app that the receiving app has given xpromo to lock in xpromo on that date. Any other app in the system can, either by default, participate in the xpromo, or by triggers or pre-provided rules not provide xpromo to that app.

If the network contains a “mandatory” condition, then that could override certain rules. For example, in the example scenario of FIG. 2a, App A-1 receives xpromo from companies B-D. In the example provided, it is unclear which apps of Company B-D are actually providing the apps, but for the purposes of this explanation it is not needed and we can assume apps B-1 through D-1 are providing the xpromo. Generally, apps of similar genre, type, etc. provide better xpromo than dissimilar apps, as the users tend to gravitate towards a limited selection of genre, type, etc. of apps. If A-1 and B-1 were similar apps, and B-1 sends an efficient amount of xpromo to A-1, meaning that either the CTR or install rate is higher than normal ads, then the “mandatory” condition is put in place to ensure that A-1 does not get the advantage of this and not pay that debt back. Company A-1 may not want to pay the debt back to B-1 because B-1 may be a competing app; however, A-1 never would have received the xpromo in the first place had B-1 not given its valuable xpromo to A-1 in this example. Alternative debt-driven xpromo systems may not have the mandatory condition, or may have a rule to prevent the triggering of the mandatory condition. For example, Company A may choose not to receive any xpromo from Company B because they are competitors; Company A may not want to be required to give xpromo to Company B, even if Company B is willing to overlook the fact that they are competitors. Therefore, the system may simply not route any xpromo from Company B to Company A.

Column 2004 provides the first time that a company used the x-promo. For the purposes of the example, we use “date” to indicate that the xpromo runs over a period of a day; however, xpromo campaigns do not always have to run over a single day, nor do they have to start at the beginning of a single day. For instance, an xpromo campaign can start on a first date at midnight and run till the end of the day at midnight. More likely, a campaign might want to start at 6 am or the beginning of the day of the Receiving App's most likely demographic or target time zone, and then end at the late night, around 1 or 2 AM the next day. Campaigns could last half a day or campaigns could last several days but throttle at different rates. For example, there could be a campaign running that gives 100% of traffic from all apps in the debt-driven system to two different apps. The campaign could throttle them equally, with the first and second Receiving App receiving 50% of the traffic, or the first receiving app receiving 70% while the second receiving app receives 30% traffic, traffic meaning the ads or xpromo views or clicks, etc. that are provided by users. Alternatively, an app may be designated as the overflow xpromo. For example, if App A-1 is receiving traffic on a particular time segment, then it also has xpromo that it could give to other apps and it could potentially redirect all its xpromo to another app in the network to take advantage of all the traffic it is getting. Also, when two apps are receiving 50% of a campaign, the two apps may redirect all their xpromo to each other, so that the full strength of the network is being driven to the two apps, even from the apps that are receiving the xpromo.

Even though 100% of the xpromo may be given, they may not be all directed to a single app. There may be several other reasons why the system may re-direct traffic in this manner: (1) to dynamically adjust for an app reaching the rankings; (2) to allow for new companies into the system; (3) or to abide by the request of the receiving company that does not necessarily want to gain in the rankings.

Regarding the first reason, the system may dynamically alter the rate at which a particular Receiving App receives xpromo if it detects that one is starting to gain in popularity and has a chance of getting into the rankings. One of the example advantages of the debt-driven system may be that it allows for a greater likelihood for a receiving app to get into the rankings. The system may detect, for example, a sudden increase in CTR or install among a certain Receiving App. If that Receiving App is about to get installs at a frequent rank that indicates it is likely to enter the rankings, then it may be a good moment to bring it past the tipping point. As the markets are constantly changing their methodologies to determine what factors to weigh in putting an app into the chart rankings, the debt-driven xpromo system will also have to adjust accordingly. Alternatively, the reason the xpromo system may redirect traffic to a Receiving App may be if the system may detect a particular interest from a particular segment of the network user base. If the Receiving App is localized for a particular country, such as China, and the time zone happened to peak for users in China to be installing apps, this could be detected by the xpromo system. Ultimately, two Receiving Apps could each get 50% of the total traffic delivered that day by volume, but through the day, the balance of delivery alter between the two Receiving Apps.

Regarding the second reason, as an xpromo network grows, it may be more difficult to allow all of the apps in a system to get their xpromo scheduled in a fair and efficient manner. If there were only 7 companies in the xpromo network, as shown in the FIG. 2a, and there were only 1 app per Company, then it would be easy to see that over a year of 365 days, each app could get a fairly even distribution of scheduling approximately 52 days each of xpromo if every single day was used for xpromo. Though, it is not likely that every app will want to receive xpromo for every single day of the year. However, if the network were increased such that there were more the 365 companies or more than 365 apps, then the potential for conflict in scheduling increases immensely during the year. Therefore, there may be a need to split the xpromo given by the full network. For example, some apps may be targeted for different language localities or cultural localities. Localization targeting makes a big difference in terms of getting higher CTR or install rates from xpromo. Moreover, some apps are only available on a single platform, while others are available on multiple platforms.

Different xpromo will have varying effectiveness for different applications, and the xpromo network will have to be adaptive in order to provide the most efficient xpromo to the apps in the system. It may be possible that the xpromo network will have to split the network into groups. In such a case, the xpromo network may group all the games of similar genre together to increase the possibility of high CTR or install rate. Alternatively, the xpromo app may group apps so that there are no overlapping apps of the same type at all. It is potential that one type of user may just not have exposure to other types of apps or genres. Exposing users of different genres and types may potentially be helpful as well in order to grow the overall users in the network; otherwise, users may be shuffling from one similar app to another app without really growing the organic user base.

Alternatively, genres or types of games may be given points, and the xpromo system may drive apps of a similar genre but a different theme. For example, all the zombie themed apps may be grouped together to drive xpromo to each other, even if one is a tower defense game and another is an invest-and-express game. Later, the xpromo may re-divide the apps such that the apps are not grouped by theme, but rather by type of game. Therefore, the previous zombie-themed, tower defense game may drive xpromo to a fantasy themed, tower defense game. In this way, the xpromo network may be able to maximize the potential exposure of users to new apps that they may be interested in. The xpromo network grows because of the viral growth when a user discovers a new and exciting type or theme of game that he can share with friends.

Regarding the third reason, it may be possible a Company A is owed xpromo to one app, but it wants all of its xpromo driven to a newer app. Then Company A may decide to split xpromo so that A-1 receives 30% while A-2 receives 70%. In the meantime, within A-2, it may try and upsell users to a paid version of the app, while A-1 is similarly driving xpromo to A-2. Or, a company may know that A-1 is an older app and would not be as successful in an xpromo campaign. Therefore, there are many ways a Company could decide to allocate the xpromo. Alternatively, Company A may have apps A-3, localized to China, and A-4, localized to the US. It may allocate the xpromo 100% going at 50% of the day in the U.S. in Central Standard Time, and the rest of the 50% going full blast at nighttime of Central Standard Time, while China has its daytime.

FIG. 2b illustrates an example of how apps can enter the system and another example of how the xpromo may be structured. Row 2100 shows the headers that indicate the type of value that is in the columns. Column 2101 shows the company identification number (“CID”) of each of the companies or developers, whose full names are identified in Column 2101 under “Co” for company. In this particular example there are 8 companies identified as A-H for purposes of simplicity. Column 2102 now identifies the specific apps that are made by a company in Column 2101 and that are available to provide xpromo. Column 2104 provides the “date entered”, which would be the date the particular Company entered the xpromo group or the date the particular app was entered into the xpromo network. There may be various reasons that a Company may have an app but that it is not entered as part of the xpromo network, possibly due to rejection by the Company or rejection by the xpromo network.

An app may not always be capable of being entered into the xpromo network, but this may be determined by an administrator of the Company as well as the rules or administration of the xpromo network. Typically, for the xpromo network to operate, the apps in the network must have ads in order to provide xpromo. Without ads, there may not be a venue to xpromo another app, as it is the simplest form of xpromo. Common practice in most markets is to have “free” apps have ads in them, while “paid” apps, those which a user has to pay in order to simply download the app, to be free of ads. The idea is that the user has exchanged money in order to be free of the burden of viewing ads; whereas, a free app is, in-part, subsidized by the display of ads. Therefore, an x-promo network may not allow any paid apps to enter the system, in the sense that they are unable to receive xpromo because they do not contribute any xpromo. The requirement that all apps of a company must provide be “free” is such that, if the point of the xpromo network is to increase the user base of the network, providing xpromo to a paid app typically does not help to maximize the efficiency of the system. The reason for this may be because typically CTR and install rate of free will be higher than pay, as a user has to overcome the monetary threshold before they will try out an app.

It may not always be the case, however, that a paid app is unable to provide xpromo. In such cases, it may be allowed into the network if it can provide alternative and sometimes even better levels of xpromo than an ad. For example, some apps have app “news”, which is typically the news related to the app. Oftentimes, CTR or install rates are higher because the “news” is associated with the goodwill of the brand of the app. Many “paid” apps have these “news” tabs and they are not viewed as “ads” by users because they also provide an information service to users, typically informing them of new updates to the app, changes to terms of service and privacy policy, etc., which a user would typically want to know. Occasionally, if this space is used for “announcements” regarding other apps then users will overlook the use of this space; of course, if it is overused for ads then users may ignore the news tab, to the detriment of the app. Therefore, this is an issue that would have to be monitored by the developer. Another way a “paid” app may be able to provide xpromo is through an “offer wall”. Many apps, particularly game apps, have in-game currency which is typically purchased via real world money through an in-app purchase (IAP). The money may be transmitted to the marketplace of the platform and the in-game or virtual currency may be provided to the user. As an alternative to providing real money, some apps may provide “actions” that a user may perform to receive in-game currency. Actions could include the viewing of an ad, playing another game, installing another game, etc. Because the “rewards” for performing the action are greater for users, this form of “xpromo” may be even better than a typical ad, particularly for those that are highly engaged in the app. However, this form of xpromo may also perform lower for paying users, those that already buy in-game currency, which are typically the more desirable type of user, particularly for freemium apps. Freemium typically refers to apps that are free on the marketplace but make their money through IAP after a user is already engaged with the application, rather than making the revenue upfront by having a user pay simply to download or install the app.

Some administrators of an xpromo network may allow for paid apps to receive xpromo even if they do not have the capability of xpromo back. This may be the case if the xpromo network is able to partially benefit from the revenue received by xpromo to a paid app. For example, if a paid app receives an increase in install revenue due to the xpromo, the xpromo network may take a revenue share and use that revenue to pay for users on ad networks. There are many ways to allocate this additional money. For example, the money may be collected into a pool and distributed among each app, it may pay for administrative costs of the server and reduce any fees that companies have to pay to be a part of the xpromo network, or it may automatically be directed to the next app that is schedule to receive xpromo.

In FIG. 2b, Column 2104 shows that a company may have an app available immediately upon joining. An xpromo network may make this a requirement before joining; however, there may be reasons for allowing a company without any apps to join. For example, Company H has entered as of “2/1/2012” but it is not showing any apps. While it may not be able to contribute immediately to the network, it increases the visibility of the xpromo network aligning itself with the network; thus, allowing it to possibly attract other companies that do have apps immediately available to provide xpromo. Moreover, a company that is currently developing an app may be awarded with this early registration in the system by having seniority in the system. Seniority may be one of many factors that will later resolve conflicts, such as in scheduling, revenue share, etc.

Column 2105 lists the date that an app first used an x-promo. Later on, as a company or an app has gone through several cycles, then each app may have multiple dates listed or simply the last date that xpromo was listed. This may be simply to help keep track of scheduling, as another factor for resolving conflicts may be how recently a specific company or app has either provided xpromo or received xpromo. From cell 2106 onwards indicates whether an app is receiving xpromo or not and lists the apps that contribute their bandwidth of xpromo to that application. Therefore, columns 2107 to 2110 indicate the xpromo received by the receiving apps, as listed in Row 2100, which would be A-1, B-1, C-1, F-1, and A-2 or Columns 2107-2111, respectively. Interspersed within the fields of Column 2112 are both the balances per company, as well as, per app within the company. For example, the balance of App A-1 is “1” as indicated in Field 2113, and the balance of App A-2 is “−1” as indicated in Field 2114, while the total balance of the Company is “0” as seen in Field 2115.

There may be different ways for the xpromo network to break down and weight the xpromo given. For example, the xpromo network may treat each individual app as its own entity and the apps have their own balance. In the FIG. 2b example, the xpromo is credited by Company; therefore, when A-2 receives xpromo from A-1, A-2 does not list a credit to A-1 for providing that xpromo because it comes from within the company. Alternatively, the xpromo network may treat each company as a collective, so that if the Company provides one app for xpromo and wants the other app to receive xpromo that can be “credited” by the xpromo network. However, the key point to note is that apps in this debt-driven xpromo network are never “credited” due to volume that is contributed, rather, they are “credited” for being available to help drive traffic, regardless of the amount they contribute, so that other apps on the system may become a “hit” and overall drive organic installs into the network, as the focus is trying to get a specific app driven onto the rankings rather than to simply “exchange” traffic.

As can be seen in FIG. 2b, some apps may be available at the time that apps need xpromo, but they may not be offered. This is shown in the example of App E-1, which while available as of “1/1/2012”, never offers its xpromo. This may be due to the fact that it does not fit into one of the restrictions of the xpromo network. For example, if it is an app on a specific platform, such as Blackberry, and there are not other apps on the platform that are Blackberry, then it may not be able to give xpromo. Alternatively, the xpromo network may be able to credit apps, even if they are giving xpromo on one platform but receiving on another platform. Some xpromo networks may not require that a Company with free apps must contribute all their traffic from all their apps that can provide xpromo, but other xpromo networks may make this a requirement for the very reason that it does not want companies withholding traffic. A company may hope that one app becomes a hit and then use that traffic to drive its other apps and thus not have to contribute to the xpromo network. To prevent this circumvention, the xpromo network may make it a requirement that once a Company becomes involved in the xpromo network, all apps must be included. There may be some exceptions based on content. For example, the xpromo network may disallow all lewd, pornographic, or any other type of app that promotes behavior of a certain nature. Or, other companies may request that their apps not be shown in other company's apps because they don't want their products associated with those apps. An xpromo network may allow apps to be “grandfathered” out of the xpromo, that is if the company was already in the network but never received any xpromo, then they may be allowed not to provide xpromo, but then like in the case of App G-1, once it has received xpromo, as in Field 2116, then it must also start giving xpromo, as shown in Field 2117. App G-1 may have first received xpromo elsewhere, but it is not shown in this table.

FIG. 2c illustrates an example subset of how each Company's xpromo traffic may be credited. In the previous figures, the xpromo network tracked all the companies and apps. This particular example structure does not necessarily need to correspond to those previous examples. For ease of explanation, however, similar naming conventions are used. Thus, in this table, Field 2201 indicates the Company that we are referring to, which is Company A. In the table, the Company has three apps available at the snapshot in time, which are App A-1, App A-2 and App A-3, as indicated by Fields 2203, 2206, and 2209, respectively. The Received Field 2204 indicates that it is tracking the xpromo received for each app. The other apps listed in a column are the ones that drove xpromo to the app on the particular xpromo date, which is indicated on Row 2200. For example, App A-1 of Column 2203 receives xpromo on “1/1/2012” as indicated by Field 2202 from Apps B-1, C-1 and D-1. App A-2 in Field 2206 receives xpromo on “2/5/2012” as indicated by Field 2205 from apps B-1, C-1, D-1, and F-1. App A-3 in Field 2208 receives xpromo on “3/3/2012” as indicated in Field 2207 from Apps

FIG. 2c explains how when apps are introduced later, such as A-2 on “2/5/2012” as indicated by Field 2205, there may be more apps available to provide xpromo, such as App F-1, which was available to xpromo to A-2 but not to A-1 when A-1 was receiving xpromo from the network on “1/1/2012” as indicated by Field 2202. By the time A-3 in Column 2208 enters the network and receives its xpromo on “3/3/2012” as indicated in Field 2207, even more apps G-1, H-1, I-1 and K-1 have joined the network to add in xpromo. Similarly, when A-2 of Field 2209 receives xpromo for its second time on “4/10/2012” as indicated in Field 2210, L-1 has joined the network to provide xpromo. Track and storing Apps that have given xpromo are so that if any of the Companies (or if credited individually any of the Apps) seeks to be removed from the network; that there is a plan of apps that are “owed” a debt that would have been paid off. However, if Company A wanted to leave, then before it left the network it would have to at least take part in an xpromo of the ones that had contributed previously. One reason an xpromo network may want to do this is because a debt-driven system works and operates differently than a click-exchange network which simply credits on volume. In a debt-driven xpromo network, the applications or company, or whatever paradigm of grouping is provided, is driven by debt of total traffic. A paradigm of grouping simply means the aggregate total traffic completely driven by a single entity. For example, if the network was large enough, it could be possible that instead of grouping simply by app or Company, that a grouping was an entire genre with multiple companies. This may be useful for when the xpromo network gets particularly large. Or, another grouping could be by platform; for instance, if many companies launched on two different platforms (e.g. iOS, Android, etc.), then the Android group could provide traffic for the iOS group.

One key example difference between a debt-driven xpromo exchange is that because the network is ideally growing by adding users organically to the system, by getting users from the rankings, then it is ideal that before a company leaves, the benefits of those “new users” to the xpromo system are retained. Otherwise, it would be simple to circumvent the system by simply entering, receiving xpromo and getting into the rankings, gaining a lot of users such that the company can xpromo to its own apps without other companies' help, and deciding to exit the system. In a click-exchange network, this is neither possible, nor would it be tolerated. The reason being is that users have to “earn” credit first before they can use the credit to gain users. Even if credit is provided without providing xpromo, it is usually given as an incentive to join the network, but typically does not drive new users into the system.

The goal of a click exchange network is to allow users to trade, and the trading is always within the same network. This is because users have to exchange across the same technological network because one network's server tracking is not going to share volume provided to another network. For the sake of simplicity of math, assume we have a click exchange with ten apps, each with one-tenth of the network of users and none of the users overlap. If there are 100,000 users in the click exchange network, then each app has 10,000 users. Assume also that the xpromo performs at 100%, and all the apps are able to do a 100% click exchange. Typically, because it is a click exchange, user exchange is done slowly over time. A first app may give 10 users to a second app and then be “owed” 10 users or a certain number of ad views, depending on how the click exchange network is run. The second app then gives 10 users back to the first app, or possibly a third app gives 5 users to the first app and a fourth app gives another 5. Gradually, even with 100% conversion rate of all the users, each app eventually reaches 100,000 users each. The problem with the click exchange is that the click exchange network's user number has not changed. It is still at 100,000 because no new users have entered the system from the click exchange.

In the debt-driven model with the same scenario, we have the same 100,000 users in the system and the same breakdown of each app having one-tenth of the users. However, instead of requiring some traffic in order to get some traffic, all ten apps on schedule to provide all their xpromo capability at a single time. First, we note that none of these apps have to be in the same network because volume is not tracked. Second, if we assume that 90,000 of the users are directed to the first app at the same time, and the first app gets into the rankings giving it organic growth of an extra 10,000 users, then the first app now has 110,000 users. The first app has the original 10,000 it had, it has an additional 90,000 from the other 9 apps, and it has 10,000 organic growth users. The second through tenth app, still only have their 10,000 users; however, now the overall debt-driven network has an additional 10,000 users in the system. This 110,000 can be later used to drive traffic to the second app, and if we assume the same rate of conversion, it could possibly gain even more new users into the system, and the network continues to grow. Unfortunately, because the network does not pre-collect the volume as there is no “exchange”, there may be potential for users to seek to gain the benefits of the system and then immediately leave the system. Or, alternatively, there may be legitimate reasons why the company developers may want to exit the system despite their tremendous boost in users from the system. For example, they may enter into legal obligations or want to enter into legal obligations (such as a merger or acquisition), that would generally preclude these types of partnerships. Therefore, the system can plan one of several types of exit strategies.

One potential exit strategy for a Company that has received xpromo from the debt-driven network may be to determine the specific companies that had ever contributed to its xpromo. This is where the fields in FIG. 2d are applied. Alternatively, the xpromo network could simply allow the Company to exit after returning the amount of debt, by number of apps it was supposed to xpromo to, by simply giving to the next scheduled xpromo blasts from the network. For example, if in FIG. 2d after App A-2 receives its xpromo and decides to leave, then it would have to pay back two xpromos. It could have to pay each of the xpromo back to B-1, C-, D-1 and F-1, each of the apps that had once given it xpromo. Alternatively, since it only got two xpromos, the system may only require it to give back two, such as to B-1 and C-1. Or, alternatively, the system may simply require A-1 and A-2 to give to the next scheduled apps, which could be G-1 and H-1.

FIG. 2d illustrates an example of tracking the relationships of sending and receiving for an individual company. In the example table, two company's applications are being tracked, those of Company A & B. Company A has applications A-1 and A-2 as shown in fields 2301 and 2305; and, Company B has application B-1 as shown in field 2309. This is a relative inverse of the type of relationship that is shown in FIG. 2c because the values indicate which apps receive xpromo from a given app. Row 2300 reveals the headers that show the values in the column. The term “Given” in fields 2302, 2306, and 2310 indicates that the apps listed below that field show the apps that would be receiving xpromo from the sending apps 2301, 2305, and 2309 on the associated dates 2303, 2307, and 2311, respectively. The apps under the “Directed to” fields are the receiving apps.

For example, to read the first two columns: xpromo is given from App A-1 and “Directed to” the receiving App B-1 on “2/12/2012”; xpromo is given from App A-1 and “Directed to” the receiving App C-1 on “3/1/2012”; xpromo is given from App A-1 and “Directed to” the receiving App D-1 on “1/4/2012”; and, xpromo is given from App A-1 and “Directed to” the receiving App F-1 on “3/5/2012”. Similarly, in the example, xpromo is given from App B-1 and “Directed to” the receiving app C-1 on “3/1/2012”, and so forth. The table simply provides how the receiving apps can be tracked per app. Therefore, if a company wanted to withdraw, depending on the requirements for withdrawal from the network, each company would know which other app was available in the network at the time and who needs to repay the debt before leaving.

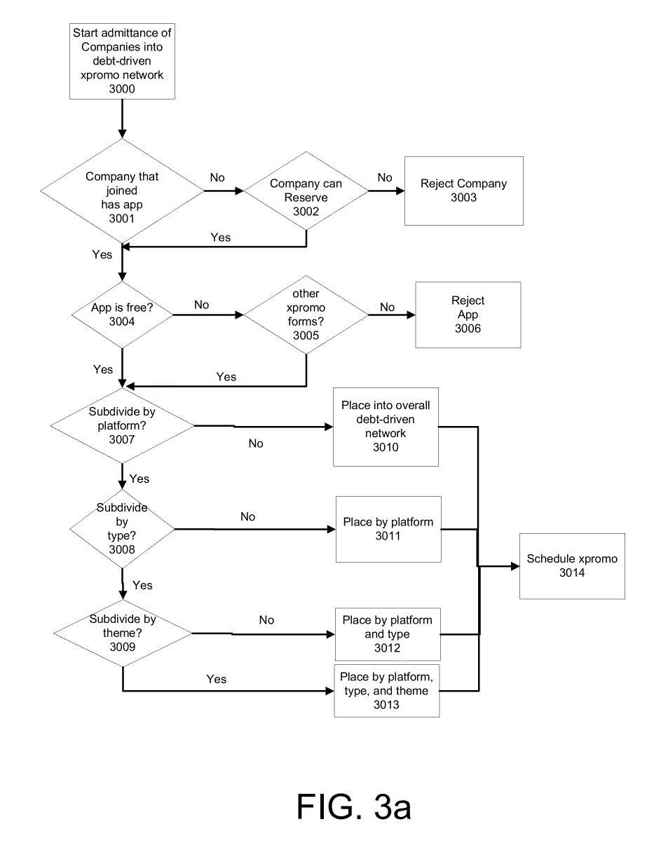

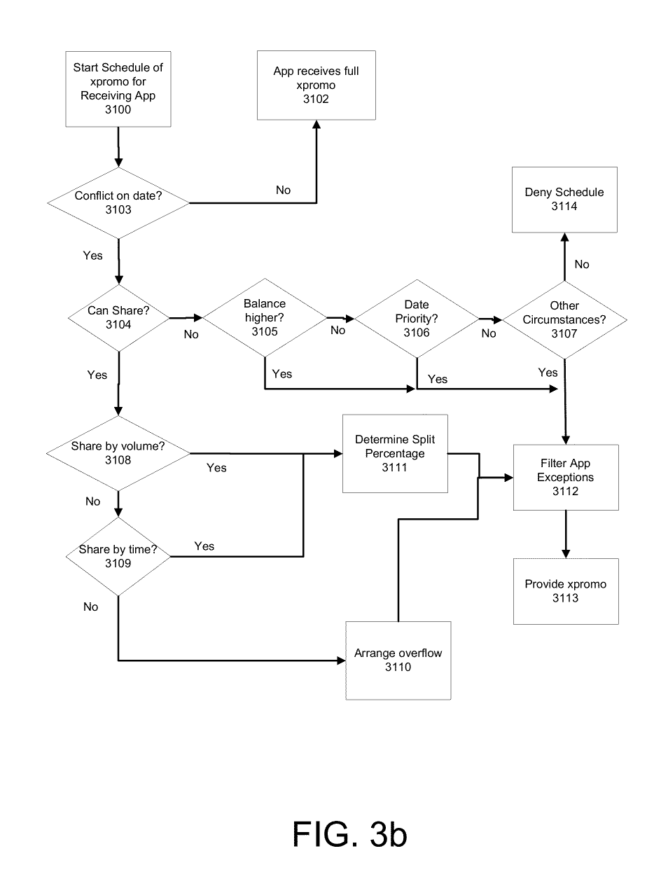

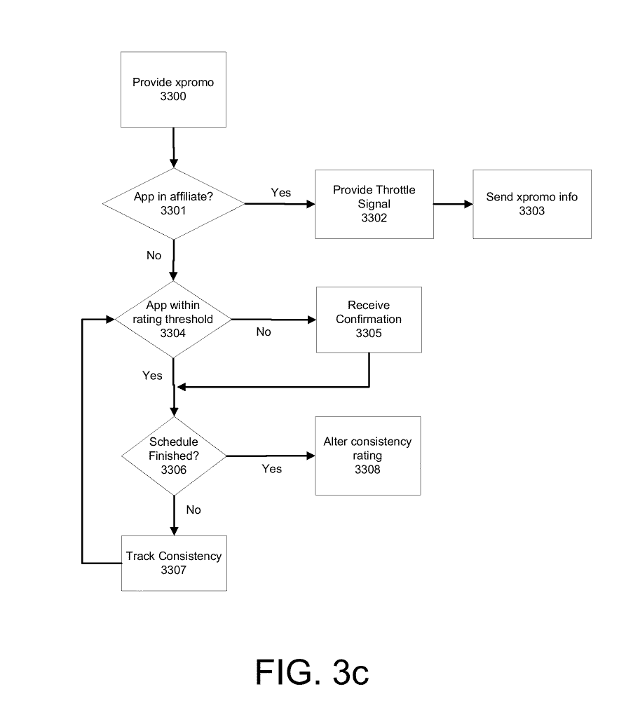

FIG. 3a depicts an example process flow of integrating new companies and apps into the debt-driven xpromo network and routing the bandwidth between the apps. The system first starts the admittance of companies into the debt-driven xpromo network 3000. The system determines whether or not the Company has an app 3001. If the Company does not have an app, then the system must determine whether the Company can reserve a priority spot 3002. If the particular xpromo system is full or determines the Company ineligible, then it can reject the Company 3003. However, if the Company can reserve and has an upcoming app that is in process, then the system can go through the app approval process, starting at 3004. If the Company that was joining already has an app, or several, then for each app it can go through the approval process, starting at 3004. The app approval process first determines whether the app is free 3004. If the app is not free, then presumably the app is “paid” and the system has to determine whether there are other xpromo forms 3005, as explained above. In other words, if the paid app can provide an “offer wall”, a newsfeed, or even simply provide ads and xpromo even if users are paying to download the app. If the paid app has no xpromo capability at all, the app may be rejected 3006, though the app may still remain in the system if the system allows for a Company to submit apps to receive xpromo if its other apps can send xpromo.

If the app can be placed into the xpromo system, then the system determines how the xpromo system is divided and where to place the app. The system determines if xpromo is divided by platforms 3007, and platform can mean one of many things. A platform could be technical, social, etc. For example, from a technical perspective a platform could be divided by OS, such as by Android, iOS, Blackberry, Windows, etc. On the other hand, the social platform could be Facebook, Twitter, MySpace, etc. Either a technical or social limitation are potential limitations of an app and potential reasons why traffic between the apps would not be as useful, or not even be capable of sending xpromo to each other. If it is a technical limitation, for example, Android apps generally cannot send traffic to other iOS apps as the marketplaces of the OS's are typically not available on the other OS's marketplace. Sometimes, the limitations are also legal because the Terms of Service or Terms of Use agreements that developers sign when developing apps limits advertisements or xpromo for apps on other platforms. If the xpromo system does not separate by platform, then the app is placed in the overall network 3010 without any split.

If the app can be subdivided by platform 3007 the xpromo system then determines whether there can be a sub-division by type 3008. Type can be by any number of divisions. The type can be how the marketplaces themselves are divided; for example, each marketplace divides how they distribute apps. Typically they are by gaming and non-gaming apps, where each of those are further subdivided. Gaming typically has a subdivision by action, adventure, arcade, board, card, casino, educational, family, kids, music, puzzle, racing, role playing simulation, sports, strategy, trivia, word, etc. While non-gaming apps can be placed under books, business, catalogs, education, entertainment, finance, food, drink, health/fitness, lifestyle, medical, music, navigation, news, productivity, reference, social networking, sports, travel, utilities, weather, etc. If the app cannot be sub-divided by type, then the app may be simply placed into the xpromo network by its platform 3011.

Otherwise, the xpromo network system determines whether the app can be subdivided by theme 3009. A theme could be along the lines of a genre, such as fantasy, sci-fi, anime, western, etc. If the app can be subdivided by theme then it may be placed in the xpromo system further sub-divided by this theme 3013; otherwise, it may be simply not sub-divided by genre and placed in the xpromo 3012. After the app and company have been sufficiently allocated to the system, it can proceed to schedule its xpromo 3014. The process of adding the app and sub-dividing by platform 3011, type 3012, and theme 3013 can be done by any hierarchical order, as the eventual goal may be to put them in the proper group so it can have its xpromo scheduled 3014. Thus, in alternative forms, apps could be subdivided by theme, then type, then platform, etc. Moreover, apps may be further subdivided by a specific variable or grouping should the number of apps exceed a threshold value. Type, platform, and theme are simpler three example overarching categories used in a method to group apps.

FIG. 3b depicts an example process flow of integrating new companies and apps into the debt-driven xpromo network and routing the bandwidth between the apps. After a company or app has made the app available for giving xpromo, it can also potentially schedule to receive xpromo for that app 3100, or other apps within the company depending on whether a company is treated as an entity as a whole or whether each app has its own debt within a system. If there are no conflicts on the date 3103 or any other time segment in which a user can receive xpromo allocation, then the app can simply receive the full xpromo from the other apps in the system 3102.

If there is a conflict, the system has to determine whether or not the system allows the xpromo to be shared 3104. If the xpromo cannot be shared, then a conflict resolution process is enacted. Any number of factors can be given priority in the system. FIG. 2b provides one possible example of prioritization. The system can determine if balance is higher 3105, in other words, if an app has given more xpromo to other apps, in terms of times it has given and not volume, than it has received compared to the other apps that are scheduled on the conflict, then it has “priority”. If the balance is higher, it qualifies to get xpromo 3113, but must have app filtering 3112, which is explained below. If its balance is not higher or ties with other apps in terms of its debt balance, the xpromo system determines if the app has date priority 3106. The date priority may be the date in which that app first entered the system, when the company first entered the system, when the app last gave xpromo, or when the app last received xpromo. For example, if the app received xpromo more recently than another application, it may have less priority. However, if the app recently gave and received, this may balance out. This weighting is determined by the administrator of the xpromo network. For example, the administrator may set a ratio such that no application may schedule another xpromo if its send-to-receive ratio is lower than 1-to-5, but exceptions may apply if other applications are simply not scheduling applications. Alternatively, the administrator may set various quotas, such as a minimum of 5 sends before the send-to-receive ratio may be lower than 1-to-5, otherwise the ratio has to be higher than 1-to-3. If an application has date priority then it may also be provided xpromo allocation 3113; however, if it does not, then the xpromo network may factor in other circumstances 3107.

There are many methods for weighting and resolving conflicts. One way is to determine the highest priority items and determining whether one “wins” the conflict. For example, if ratio is the most important criteria, you wouldn't look at the next criteria, such as the last date that an application received xpromo, if one app won the first conflict criteria. On the other hand, the xpromo network may assign a priority score to an application which encompasses all the various factors based on weight. For example, the date of last xpromo, ratio of send-to-receive, total number of applications times it has sent, consistency rating, etc. could all be translated into a score and each have its own rating. The final score could be a number, a grade, star rating, etc. that can be used to compare against other applications' conflict scores.

Other circumstances 3107 may vary where the app may get priority; for example, if one app happens to have a special event, like a special sale, or it is launching on a specific time, then it may be given priority. Or, if it happens to be purchasing a significant amount of ad space, it may be beneficial to let that app have priority as it may help the xpromo network achieve getting one of its apps into the rankings. If the app does not get any factors contributing to it in terms of priorities of balance, date, and other circumstances, then it will be denied its request to be schedule to receive xpromo 3114. Otherwise, it will be allowed to receive xpromo 3113.

The xpromo system may have been able to resolve the scheduling conflict on date 3103 if it allowed sharing of xpromo bandwidth 3104. If it allowed sharing then it would simply have to determine how the sharing could be done. For example, if it allowed sharing by volume 3108, then the system would simply have to determine the percentage to split between the apps that are conflicting 3111. If, on the other hand, it didn't want to split by volume but the apps happen to be in different time zones, it could split by time 3109. Then it would have to determine the percentage split 3111 based on the parts of the day or peak periods that overlapped. Or, it would possibly do a mixture of both. For example, if the two apps were localized to the United States and the U.K., the daytime could have an overlap between the two. In the periods where the daytime did not overlap, the xpromo could give one app the full bandwidth. However, in the periods with daytime overlap, the apps could split the bandwidth 50/50. Or, there could be any other number of factors that could determine a different split percentage, such as any of the special circumstances mentioned above. If the apps could not share by any of the normal factors 3108 or 3109, then it could simply share by overflow 3110, meaning that a first app may receive all the xpromo but then at the same time, it is running xpromo to the second app, and if there are more apps conflicting, the second to the third and so forth. The largest amount of users would have entered the first app on the same day, when it is receiving the xpromo. Therefore, before the system loses those users from being retained within the system, the app receiving xpromo should redirect its xpromo to another app in the system that could possibly retain those users better.

After it is determined which app(s) receive xpromo, either through a split 3111, as overflow 3110, or completely to one app 3105-3107 then apps may be filtered out. An app may be filtered out for one of many reasons, such competitor apps that have already pre-set not to receive or send to certain other apps, apps that do not want to advertise to certain types of other apps (such as pornographic or other apps), or apps that cannot advertise to others due to content. For example, some apps may be targeted to children below the age of 13, such as educational apps, and may not be able to xpromo to apps themed with simulated violence, etc. After the apps are filtered out 3112, the rest of the apps in the xpromo network provide the xpromo 3113.

FIG. 3c depicts an example process flow of passing information between the various networks to provide the xpromo. When an app is providing xpromo there are two primary pieces of information that needs to be transferred: (1) the actual xpromo and associated information; and (2) a network check, including the schedule breakdown. The xpromo provided will typically have associated file information, such as a picture of the actual advertisement or affiliated code information. For example, if it is a picture it would be a photo asset. If it is code information, such as for an “offer wall”, there will be art assets that allow users to view the offer wall, as well as in-game currency information. A network check would be a simple network confirmation that the xpromo was sent. This network traffic does not have to be sent to the same server as the xpromo information. The reason being is that not every app has to be on the same app or ad network, and, in fact, some apps may be in click exchange networks all of which are unrelated. When an app giving xpromo requests to display an xpromo ad, it requests from the individual ad networks or click exchange network the information to display. The ad network simply has to route the information related to the ad.

As each individual instance of an app on a device is providing xpromo, it can send a request out to the xpromo network to obtain the xpromo information 3300. If the app is an affiliate of the xpromo network 3301, then the xpromo network simply needs to provide all the ad information to the app providing the xpromo 3303. This ad information could be pictures, code, and it can also include a network link or address to the marketplace to where the user can best obtain the app. For example, if the app is only available on a different platform than the device that is opening the ad, then it can provide a URL to open a website to the marketplace; otherwise, if it is on a device on the same type of platform as the receiving app, then it can open the marketplace store directly. Further, because the sending app is within the xpromo network, it may have a higher consistency rating, meaning that it is more trusted to meet its obligations to send xpromo. Therefore, normally the xpromo network may require intermittent checks indicating that it is actually displaying the xpromo. Trusted apps may throttle the checks 3302 so that network bandwidth is not wasted. The more trusted an app, the less it has to check-in every time with the xpromo network. Note that this is not to indicate the volume of ads being delivered, rather it is to indicate that the app is fulfilling its xpromo obligation. The xpromo network will also send all the xpromo info 3303 and signal to the sending app to cache the information and not to request the data from the server, again to save on network bandwidth. The xpromo network may require multiple of the checks throughout the day at set periods so that it can change the schedule or for an app not have to cache so much ad information at once. If the percentage breakdown is by time, for example, then it may send the first xpromo ad information and then indicate the next time the app should request ad information in order to cache data in successive batches.

If the sending app is not an affiliate 3301, then the rate at which the sending app will have to access the xpromo network may vary. The xpromo network will pass the schedule to the app. If the app is within the rating threshold 3304, the xpromo network may indicate a modified throttling of the signal, allowing the sending app leeway between sending confirmation that xpromo is being correctly provided 3305. When the app provides its check-ins, it determines whether the schedule has changed or finished 3306. If it has not, then it continues through the process starting from 3304. If the xpromo network determines the sending app is improperly deviating from the schedule or not providing the xpromo correctly, it may get a worse rating. This is calculated by the xpromo network to track the app's consistency 3307. If the consistency improves over time, the app may not have to keep sending confirmation and wasting a user's bandwidth, thus skipping 3305. After the scheduling of an xpromo round 3306, the app's overall consistency rating may be altered 3308.

If the app is not an affiliate 3301, the method in which it receives the advertising info may also vary. It could still send a request to the xpromo network, which acts as a proxy and passes the data between the sending app and the third party ad network. The xpromo network could simply allow the sending app to directly request from the third party ad network. The xpromo network could cash the information needed to act as a proxy and not make any further requests from the third party network, with the information cached on the xpromo network server. Or, it could pass it to the client device and request that client cache the data until it is replaced with a different information. Different information may be checked by using a checksum method or any other standard method to determine that information has changed, such as a flag variable.

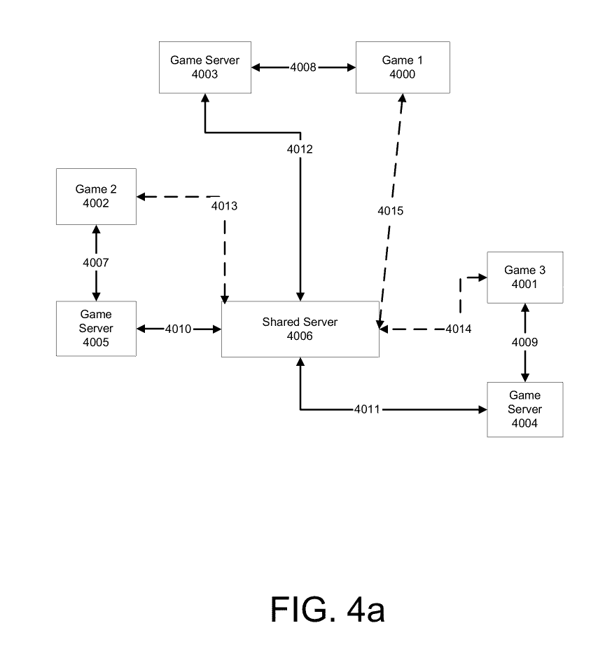

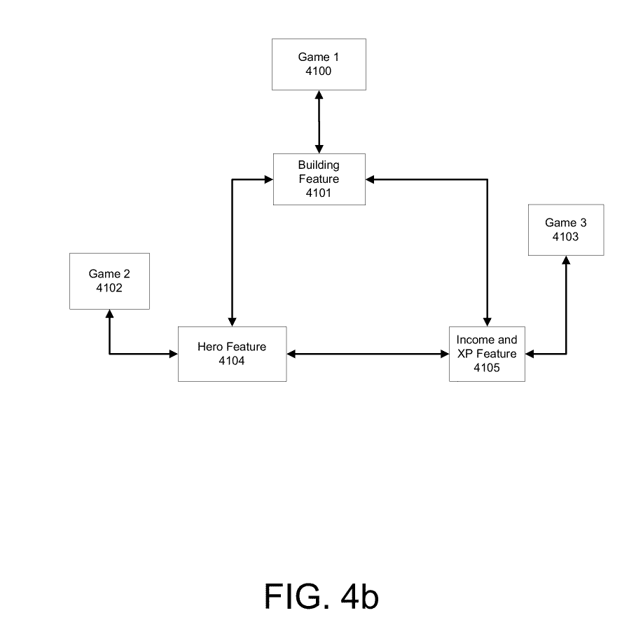

FIG. 4a illustrates an example of how apps can enter the system and how one example of xpromo may be co-structured with a cross-game feature (“shared feature”), even between apps of different genres or types. There is no limit to the number of features that may be crossed between apps or the number of apps that may be involved. In the example of FIG. 4a, there are three apps, and for the purposes of ease of explanation they are three games, but games of different types. There are Game 1, Game 2, and Game 3, 4000-4002, respectively, and each of the games are connected to their respective Game Server 4003-4005 via some type of network connection 4006-4008, respectively. Cross-game features may be sent directly from a game's Game Server to the Shared Server 4006 via network connections 4010-4012. The games may also not connect to a game server to store data, but the cross-game feature may still be connected to the central shared server 4006, which hosts the cross-game feature data. In such an alternative case, the Games 4000-4002 are connected to the Shared Server 4006 via a network connection 4013-4015 that does not pass through the game's Game Server. This is only an example structure of how data can be stored for cross-game features.

In other situations where the features are cross-game only within an individual client device, then there would be no interaction between a shared server like that of FIG. 4a. One of the Games may serve as the “central server” for the apps on the device, or, alternatively, each game may store its own cross-game feature and may simply gather the information in a central data cache stored on the client device's memory. Also, some games may not require a game server, and the traffic between the game, game server, and shared server may vary. This may be due to a developer's preferences. For example, game data may be stored on a game client device(s), the game server(s), as well as the shared server(s). This may be if syncing between games is particularly important to the gameplay. Other games may only store the cross-game features on the game and the shared server. Other games may send the game data to the game server and rely on the game server to sync the cross-game features with the shared server.

FIG. 4b illustrates a more specific example of the types of features that may be crossed between games of different types and genres. In this explanation, the methodology of server interaction will not be discussed as data may be stored in processed in any of the many methods described in FIGS. 1a-1b as well as in FIG. 4a. For the sake of simplicity, all the games will be of the same theme; however, it could very well be the case that the games have different themes.

In the example, Game 1 may be designated as an “invest-and-express” game 4100, meaning it is a game where users apply in-game currency and other in-game consumable items (e.g. energy, building materials, etc.) to build a layout of the game. The theme of the games here will be fantasy, therefore, in this invest-and-express game, users invest their in-game consumables (e.g. resources), to build a city with a castle and different buildings, such as town hall, lumber mill, gold mine, farm, livestock field, armory, barracks for soldiers, roads, flowers, etc. Users can buy and upgrade these various buildings or items to put into their simulated city. The goal of the game is to make the city with the biggest castle, most upgraded buildings, and most efficiently run while being aesthetically pleasing. The feature that may be shared cross-game in this particular example could be a single building feature 4101.

In the example, Game 2 may be designated as a simulated pet, or in the case of this fantasy theme, simulating the training of a hero 4102. In this type of game, users are given a child or several children, where they provide training schedules. The level of training depends on the money that may be spent on training the child, the ability to hire teachers, the ability to hire teachers that are skilled, the time in the game, etc. Users plan out a child's schedule and then give the child different abilities to focus on. Based on their training schedule, the child can slowly focus on becoming any of several different classes of hero that are available, whether it is a paladin or knight, a mage, cleric, ranger, diplomat, etc. The goal of the game may be to train the most powerful character to have the best attributes. The feature that may be shared cross-game in this particular example could be the eventual hero that may be produced 4104.

In the example, Game 3 may be designated as a tower defense game 4103. The purpose of the game may be to build defense capabilities ad hoc as troops arrive from enemy territories. Defense can be moving, such as troop units, or they can be fixed buildings, such as arrow towers, cannon towers, mage towers, barracks that release troops. During an attack wave, the towers or troop units may be upgraded to increase range, attack power, defensive capabilities, and other attributes. The goal of the game may be to defend the home base and to kill all the attacking troops. In-game currency to purchase upgrades and more items, artifacts, buildings, troops, etc. to defend the home base are earned through killing troops. Special experience or “xp” may be earned for killing various “boss” enemies. The feature that may be shared cross-game in this particular example could be a bank of in-game currency or xp points that can be transferred 4105.

There are many features that could have been chosen across the games, and there may also have been more than one feature chosen in each game. However, for the sake of simplicity, FIG. 4b explains an example of how only one feature per game is shared across the games. Normally, features that are shared across games are static, such as a special item or an avatar. For example, a company may reward a loyal customer that has purchased a first game with special in-game content in the second game. The two games may be tied by the fact that the character is an avatar from the first game that can be used in the second game. Or that there is a weapon from a first game that is used in a second game. There may be several reasons that games of dissimilar types or genres only use static tie-ins between games. First, if the games have dissimilar themes, then it wouldn't make sense to apply one character to the other game without pre-programming the actual mechanics of the character to give it traits that make sense in the context of the other game. For example, if an avatar in a first game is a racer in a racing game and the same look of that avatar is then used in a fighting game, there would be no known associated fighting attributes of the racing avatar. Therefore, the game would have to apply a pre-programmed list of traits to that avatar regarding the specific gameplay. Moreover, it is difficult to tie in actual game mechanics of games of different types and themes and then to balance the gameplay of both games. Another difficulty is that the unlocked characters or items that are awarded are typically tied to a single player or user.

FIG. 4b provides an example of how gameplay may be balanced such that features are shared across games and also across different users. In the example, there are three cross-game features, the building features 4101, the hero feature 4104, and the income and xp feature 4105. Within the context of the invest-and-express game 4100 of Game 1, the building features 4101 is simply one of any number of buildings that provide or receive resources and which can be upgraded. In this example, the building can be a school and nursery for children of the kingdom of the invest-and-express game 4100. Resources, such as food and in-game currency, can be used to create and educate more children, and the resource that the school produces are heroes. The more heroes a kingdom has the more points it can gain which may affect its resource production in other areas. Within the context of the hero training simulation game 4102 of Game 2, the user is attempting to schedule the calendar of the child. Children use resources, such as in-game currency, to be educated. In order to be educated, various masters of the arts must be available. Also, the nicer an environment a child has to train, the better its stats and attributes will increase. Within the context of the tower defense game 4103 of Game 3, a user earns in-game currency and xp based on the number of warriors it defeats in the game. The more warriors that are defeated or the quicker a boss is defeated, then the more xp and in-game currency is awarded.

Applications face two major problems in having a high DAU: (1) obtaining installs and (2) retaining those installs. The reason why xpromo is difficult is also because many users may simply not be interested in different genres of games. For example, a user that likes tower defense games, like those of Game 3, may never be interested in hero training simulation games like those of game 2, and vice versa. And players of both types may both not be interested in invest-and-express games, such as those of game 1 4100. Therefore, even if the xpromo system was able to get the user to install one of the other games, they would not be well-retained. One of the methods that games tend to retain users within their ecosystem is to have a social aspect. For example, in an invest-and-express game, one user may become “friends” with another user, and those users may visit each other's cities and help to do tasks, such as help to collect elements in the farm or water the farm or to help the user collect resources in the gold mine, etc. The visiting user is rewarded and the visited user is also rewarded. However, the reward is only effective if the visiting user is interested in improving their city. If they are not, then the visiting user will have no incentive to visit the city. Cross-game features may allow a user to be registered in two games, but only have to be active in one game. However, cross-game features may also be implemented where a user does not have to be registered in the second game, but may still tie their information to the cross-game feature that is being used by another user.

Cross-game features allow users to “participate” or contribute to users in different games without having to engage in mechanics that they are not interested in. For example, in the context of the invest-and-express game 4100, a first user may lend its training building to a second user that only plays the hero training game 4102. The user in the hero training game 4102 can then use this “special” building and raise better heroes with increased attributes at a faster rate. The hero feature 4104 of the hero training game 4102 may also be lent to a third user of the tower defense game 4103. The hero may help to defend the tower, thus allowing the third user not to expend as many resources training warriors and building and upgrading towers because it has a hero on the battlefield that has strong attack or defense attributes; however, the cross-game feature is administered. In addition, because the hero that was trained in the hero training game 4102 is getting “practical” experience in battles in the tower defense game 4103, it is also earning xp in the hero training game 4102 which it can apply to skill points or other points that are allocated to improve the hero's stats. Similarly, the third user now has more in-game currency and xp that it can use to give money and resources that it has saved to improve the city of the first player in the invest-and-express game 4100. The first user in the invest-and-express game 4100 may not ever have to play the hero training game 4102 or the invest-and-express game 4103 to gain the social benefits because it has made an alliance with the second and third user by applying the cross-game features. However, this does not preclude the first user from playing across all three. It may be the case that the first user does not want to play with other users. It can still use the cross-game features of the three games 4100, 4102 and 4103 to improve his situation in all three games.

In the above explanation, the flow of cross-game features is going counter-clockwise in FIG. 4b, from the building feature 4101 helping the hero features 4104 which in turn helped the income and xp feature 4105 which was used to reinvest back into the building feature 4101. However, the cross-game feature is not limited to a flow in one direction. The flow of improvement and interaction could have easily been from the building feature 4101 improving the income and xp feature 4105 to the hero feature 4104. For example, a building feature 4101 may be a special type of cannon tower. The first user playing the invest-and-express game 4100 may create this tower and lend this tower to a second user playing the tower defense game 4103. Because the tower has special attributes, it is able to kill more warriors and the tower gains xp, and perhaps during play the second user also makes upgrades to the tower for the first user. In the meantime, the second user passes along extra income and xp points 4105 to a third user in the hero training game 4102. The third user can use this income to train an “architect” hero or a research and development hero, and when this hero feature 4104 is provided to the first user in the invest-and-express game 4100, the hero can make improvements throughout the first user's city including to the building features 4101. Of course, the cross-game feature flow is now going in the clockwise direction of FIG. 4b.

It may also be the case that the developers of Game 1 and 3 do not want to work with each other but want to only work with the developer of Game 2. Therefore, the flow could easily also be that the cross-game features of Game 1 and 3, 4101 and 4105 only flow to that of Game 2 and back from Game 2, but not to each other. It is also possible that there may be a varying number of features. Game 1 may possibly have two cross-game features with Game 3 but have only one cross-game feature with that of Game 2. Even if there are multiple features being shared, it may not be a requirement for the users to use the cross-game features.

In addition, there may not necessarily be a closed circle of users using the features or even that a feature can only be shared with a single user. In the above examples of FIG. 4b, the building feature 4101 was used by a first user to benefit himself and a second user in the hero feature 4104, which benefited the third user in the income and xp feature 4105 which benefited the first user. However, the first user of Game 1 could very easily have shared the building feature 4101 with a second user in Game 2 who shared the hero feature 4104 to a third user of Game 3 who shared the income and xp feature 4105 to a fourth user in game 1. Alternatively, the building feature 4101 may have been applied to a first and a second user in game 2 who could decide not to share their hero feature 4104 with any other users. The permutations of the flow of the cross-game features and which users can use them may be determined by an administrator of the cross-game features or by limits developed by each game's developer.

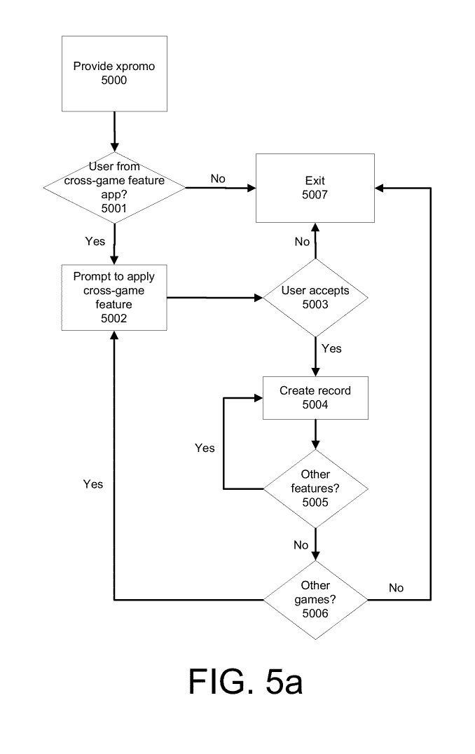

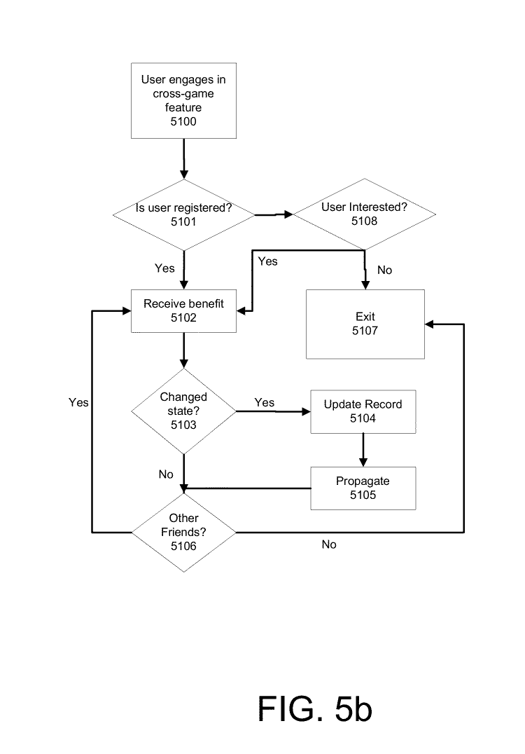

FIG. 5a depicts an example process flow of connecting a user to a cross-game feature after a user arrived at a game through xpromo. Though a cross-game feature does not necessarily have to be connected to an xpromo campaign, the retention may be more effective if done in conjunction. Through xpromo 5000 a particular app may obtain a new user. The app determines if the user came from an app that was cross-promoted from an app with a cross-game feature 5002. This determination may be made by acquiring a unique id of the user to the device, or if the user is registered on multiple apps in the system under the same username or social network id's, a central server may be able to correlate how a user arrived. An app may want to do this because it will proceed to prompt the user to apply a cross game feature 5002. If the game knows that the user came from a game with a shared cross-game feature, it could present the user interface (“UI”) in such a way that it is tailored to that user's gameplay. For example, building off of the example in FIG. 4b, if a user came from the tower defense game and into the hero training game through xpromo, the hero training game may prompt the user if it would like to lend any heroes trained back to the user's own account in the tower defense game. Or, if a user enters the system and registers using a social network, the game may identify that the user has “friends” in his social network that are playing in other games that the cross-game feature may be applied to. The user may be then prompted whether it would like to lend any heroes that are created to any friends. If, however, the user is entering the system fresh having never played any games in the system, never having registered an account, and having no friends in his social network, then the user may be prompted that cross-game features are available in other games and simply provide a list of games that it could xpromo the user to.

If the app has no cross-game features, then the cross-game feature prompt may simply exit 5007. If a first user enters the game with a first cross-game feature, the first user will be prompted to see if the first user would like to apply that cross-game feature 5002 in the game. If the first user accepts 5003 with a positive indication, then a record is created for that cross-game feature for that particular first user in that game. It may be that a second user who is receiving the cross-game feature may also have to accept, but it may not be necessary for some features where the benefit is only going in one direction. This is specific to the cross-game feature. If both the first and second user is required to accept, an invitation may be sent to the second user in the other game, and the next time the second user enters the game, the second user will receive a prompt to accept. Other records or invitations may also be sent by the first user for that same feature.

Then the game also may prompt the first user to apply for other cross-game features if there are more than one cross-game feature in the game. If the first user would like to engage in other features 5005, then it goes through the registration process again 5004. However, if the user decides not to go with any more cross game features in that game 5005, then the user may also be prompted to see if they would like to enter other games with other cross-game features 5006 or to simply install and register for other games so that the user can use the cross-game features for himself in multiple games. If the user would like to do, either through xpromo or through an in-game UI, then the user may be directed to the marketplace to install those other games. When the user enters those games for the first time, he may receive a prompt to apply for the cross-game feature 5002. This time, since he was in the first game he may be auto-detected as a user in the system and the process may be smoother to register for the cross-game features. If previously there were no other games with cross-game features 5006, then a user simply exits the prompts 5007 and can proceed to actually engage in the application.

FIG. 5b depicts an example process flow of a user using a cross-game feature. When the user engages in the cross-game feature 5100, the system determines whether the user is registered for that cross-game feature 5101. If a user is not registered, then the system may re-prompt the user to determine if that user may be interested in engaging in the cross-game feature 5108. If the user is not interested, then the system does not have to engage in the cross-game aspect of the feature 5107. If the user is interested 5108, then the user is registered and can begin to receive the benefit of the cross-game feature 5102. If the user was already registered 5101, the game pulls from the server or directly from the related game any benefits or updates of that the feature provides.

For example, if a user is training a character in a hero training game and engages in the building feature of an invest-express game, then the game receive any updates as to whether the building has upgraded. Any updates would allow the engaging user to receive the benefits 5102. If the cross-game feature is reciprocal, then the state of that user may have changed 5103, which would require an update of the record 5104, either on client or server, and propagated to all the cross-game features that engage in that change 5105. For example, if a hero's stats improved, then any game using the hero cross-game feature would require an update. If the state has not changed, the cross-game may be further boosted by other friends providing a benefit 5106. For example, if a hero needed to be trading in multiple buildings, the user would go through each process of the cross-game feature 5102-5106 for each other user providing a benefit. Once there are no other friends, the system exits 5107.

Several example embodiments of the present invention are specifically illustrated and described herein. The advantages and features of the application are of a representative sample of embodiments only, and are not exhaustive and/or exclusive. They are presented only to assist in understanding and teaching the claimed principles. It should be understood that they are not representative of all claimed inventions. Moreover, they are not to be limited to the technologies or devices described herein. That an alternate embodiment may not have been presented is not a disclaimer of such alternate embodiment. It will be appreciated and understood that other embodiments may be utilized and functional, logical, organizational, structural and/or topological modifications may be made without departing from the scope and/or sprit of the embodiments discussed herein relative to those not discussed herein other than it is for purposes of non-repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others.

In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of an individual, entity, and/or enterprise user, database configuration and/or relational model, data type, data transmission and/or network framework, syntax structure, and/or the like, various embodiments of the invention, may be implemented that enable a great deal of flexibility and customization. For example, aspects of the invention may be adapted for non-game use. While various embodiments and discussions of the invention have been directed to examples in virtual games, however, it is to be understood that the embodiments described herein may be readily configured and/or customized for a wide variety of other applications and/or implementations.

What is claimed is:

1. A method for providing debt-driven cross promotion for an application, comprising:
receiving a request from a first receiving developer to schedule a cross-promotion campaign;
resolving a schedule conflict check;
adjusting the first receiving developer's balance;
sending a scheduling response to the first receiving developer;
receiving cross-promotion data from the first receiving developer;
sending the cross-promotion data to one or more sending developers; and
receiving a verification of cross promotion from the one or more sending developers.

2. The method for providing debt-driven cross promotion for an application, according to claim 1, wherein the resolving a schedule conflict check further comprises:
receiving the first receiving developer's priority score;
receiving the priority score of one or more conflicting receiving developers;
comparing the first receiving developer's priority score with the one or more conflict receiving developers' priority score; and
determining a scheduling response.

3. The method for providing debt-driven cross promotion for an application, according to claim 1, wherein the cross-promo data is at least one of a visual graphic, video, sound file, or in-game currency offer that is paired with a network address to an application on the marketplace.

4. The method for providing debt-driven cross promotion for an application, according to claim 1, further comprising:
storing the verification of cross promotion from the sending developer;
calculating a consistency score for the sending developer; and
sending a throttle score upon the consistency score reaching a pre-determined threshold.

5. The method for providing debt-driven cross promotion for an application, according to claim 1, wherein the determining a scheduling response further comprises:
filtering cross-promotion sending developers; and
sending a campaign schedule to unfiltered cross-promotion sending developers.

6. The method for providing debt-driven cross promotion for an application, according to claim 1, further comprising:
receiving a verification that a user has engaged in a first application installed from a cross-promotion of the first receiving developer;
sending to the user a prompt of cross-game feature alternatives and an instruction to prompt.

7. The method for providing debt-driven cross promotion for an application, according to claim 6, wherein feature alternatives is at least one of cross-game features in the same first application, cross-game features in a different application, cross-game features in the same application with different users, and cross-game features in a different application and different users.

8. A method for providing a cross-game feature among users of different games, comprising:
receiving a registration from a first user for a cross-game feature of a first game;
storing a record of the cross-game feature with the first user in the first game;
storing a shared record of the cross-game feature of the first user in the second game.

9. The method for providing a cross-game feature among users of different games, according to claim 8, further comprising:
receiving an update of the cross-game feature from the first user in the first game; and
updating the stored shared record of the cross-game feature of the first user in the second game.

10. The method for providing a cross-game feature among users of different games, according to claim 8, further comprising:
receiving the registration of the cross-game feature of the first user tied to a second user in the second game;
updating the stored shared record of the cross-game feature of the first user in the first game and the second user in the second game; and
storing a record of the cross-game feature with the second user in the second game.

11. The method for providing a cross-game feature among users of different games, according to claim 10, further comprising sending to the second user of the second game an update of the cross-game feature.

12. The method for providing a cross-game feature among users of different games, according to claim 8, further comprising sending to the first user of the first game an update of the cross-game feature from the second game.

13. The method for providing a cross-game feature among users of different games, according to claim 12, altering a non-cross-game feature in the first game based on an update of the cross-game feature from the second game.

14. The method for providing a cross-game feature among users of different games, according to claim 8, wherein the cross-game feature in the first game has a first gameplay element and the cross-game feature in the second game has a second gameplay element.

15. The method for providing a cross-game feature among users of different games, according to claim 8, wherein the first gameplay element is not a gameplay element of the second game and the second gameplay element is not a gameplay element of the first game.

16. The method for providing a cross-game feature among users of different games, according to claim 8, further comprising receiving a registration of a cross-game feature of the first user in a third game.

17. An apparatus, comprising: one or more processors; and a memory coupled to the processors comprising instructions executable by the processors, the processors operable when executing the instructions to:
receive a request from a first receiving developer to schedule a cross-promotion campaign;
resolve a schedule conflict check;
adjust the first receiving developer's balance;
send a scheduling response to the first receiving developer;
receive cross-promotion data from the first receiving developer;
send the cross-promotion data to one or more sending developers; and
receive a verification of cross promotion from the one or more sending developers.

18. The apparatus of claim 17, further comprising executing instructions to:
store the verification of cross promotion from the sending developer;
calculate a consistency score for the sending developer; and
send a throttle score upon the consistency score reaching a pre-determined threshold.

19. The apparatus of claim 17, further comprising executing instructions to:
receive a verification that a first user has engaged in a first application installed from a cross-promotion of the first receiving developer;
send to the first user a prompt of cross-game feature alternatives and an instruction to prompt.

20. The apparatus of claim 17, further comprising executing instructions to:
receive a registration from a first user for a cross-game feature of a first game;
storing a record of the cross-game feature with the first user in the first game;
storing a shared record of the cross-game feature of the first user in the second game.
